(19) United States
(12) Patent Application Publication
(10) Pub. No.: US 2011/0307144 A1
(43) Pub. Date: Dec. 15, 2011

(54) METHOD AND SYSTEM FOR TRANSMITTING AND RECEIVING VEHICLE INFORMATION

(75) Inventors: BING-FEI WU, Hsinchu (TW); YEN-FENG LI, Hsinchu (TW); CHIH-CHUNG KAO, Hsinchu (TW); YING-HAN CHEN, Hsinchu (TW); CHAO-JUNG CHEN, Hsinchu (TW)

(73) Assignee: National Chiao Tung University, Hsinchu (TW)

(21) Appl. No.: 12/837,597

(22) Filed: Jul. 16, 2010

(30) Foreign Application Priority Data
Jun. 15, 2010 (TW) 099119497

(51) Int. Cl. G06F 19/00

(52) U.S. Cl. 701/31; 701/1

(57) ABSTRACT

The present invention provides a method and system for transmitting and receiving vehicle information, in which a wireless transmitting and receiving unit and a vehicle computer recording a first information is disposed in the vehicle, and a processing computer is disposed in a vehicle station. When the vehicle enters the vehicle station, the vehicle wirelessly transmits the first information to the processing computer according to a request signal. After that, the processing computer wirelessly transmits a second information to the vehicle computer at a specific time point. By means of the method and system of the present invention, it is capable of exchanging information between the vehicle and vehicle station in a wireless transmitting and receiving way so as to save the waiting time for maintenance and management.

### FIELD OF THE INVENTION

The present invention relates to an information transmission method, and more particularly, to a wireless method and system for exchanging vehicle information between a computer in a vehicle and a processing computer in a vehicle station.

### BACKGROUND OF THE INVENTION

Nowadays, vehicle maintenance and management is considered to be one of the key issues that leads to success in fleet management. In addition, thanks to the rapid advance in computer technology, most vehicles available today are equipped with trip computers to be used for recording and integrating all the information relating to the vehicles. By analyzing the information registered in the trip computers, a fleet vehicle maintenance and management plan can be scheduled and processed.

Please refer to FIG. 1, which is a schematic diagram depicting a conventional method for vehicle information transmission. In FIG. 1, a vehicle is equipped with a trip computer 100 and a self-diagnosis/registration device 101 that is electrically connected to the trip computer. Moreover, since the self-diagnosis/registration device 101 is configured with a variety of sensors for detecting all kinds of operation statuses relating to the vehicle, including the brake condition, the amount of lubricant, the amount of water in the water tank, exhaust emission condition, the ignition condition, and so on. Therefore, the personnel in the maintenance station is able to access information relating to the operation of the vehicle simply by manually connected the trip computer 100 to a processing computer 102 in the maintenance station through a data transfer cable since those operation information of the vehicle had been registered in the trip computer 100.

Thereafter, the personnel in the maintenance station is able to schedule and perform a maintenance plan for the vehicle according to those operation information registered in the trip computer 100, and then after completing all the scheduled maintenances for the vehicle, the trip computer 100 is again being connected to the processing computer 102 through the data transfer cable for transferring information relating to the result of the scheduled maintenances so as to update the information registered in the trip computer 100. Nevertheless, although the vehicle operation information can be successfully accessed and updated through the aforesaid conventional method, there can be a conceivable amount of time wasted in the connecting of the data transfer cable, not to mention that the connection should be performed at least twice in the process, which is a waste of time for the maintenance personal and the owner of the vehicle as well.

There are already many studies relating vehicle management. One of which is a vehicle communication system, disclosed in U.S. Pat. No. 6,917,306, which is designed to establish the location of emergency vehicles and related privately owned vehicles within their vicinity and have this information relayed to a third party using conventional radio transceivers. Another such study is wireless vehicle communication system, disclosed in U.S. Pat. No. 6,894,601, which is designed to achieve communications between vehicles with trip computers and a remote station via a radio frequency link established by the use of the passive radio frequency tags attached to the vehicles and an interface unit connected to a remote system. Moreover, in U.S. Pat. No. 6,917,306, a data transmission technique is disclosed, which enabling a vehicle to aware of its current location and other useful information including the locations of nearby hotels, gas stations, convenience stores, etc.

### SUMMARY OF THE INVENTION

The object of the present invention is to provide a method and system for transmitting and receiving vehicle information, by which a vehicle information relating to a vehicle is enabled to be transmitted to a computer disposed in a station in a wireless manner while the computer in the station is enabled to transmit data to the vehicle also in a wireless manner for updating the vehicle information or interacting with the driver of the vehicle, and thereby, the time required for maintaining the vehicle and scheduling a management plan for the vehicle can be shortened.

In an exemplary embodiment, the present invention provides a method for transmitting and receiving vehicle information, comprising the steps of: providing a vehicle having a wireless transceiver and a trip computer while enabling the trip computer to record a first information relating to the vehicle; transmitting the first information to a processing computer in a wireless manner when the vehicle enters a vehicle station; and enabling the processing computer to transmit wirelessly a second information at a specific point of time to the trip computer.

In another exemplary embodiment, the present invention provides a system for transmitting and receiving vehicle information, comprising: a processing computer, disposed inside a vehicle station; and a vehicle, configured with a wireless transceiver and a trip computer in a manner that the trip computer is used for recording a first information relating to the vehicle, and the wireless transceiver is enabled to transmit the first information to the processing computer when the vehicle enters the vehicle station; wherein the processing computer is enabled to transmit wirelessly a second information at a specific point of time to the trip computer of the vehicle.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram depicting a conventional method for vehicle information transmission.

FIG. 2A is a schematic diagram showing a system for transmitting and receiving vehicle information according to an embodiment of the present invention.

FIG. 2B and FIG. 2C are schematic diagrams showing two systems for transmitting and receiving vehicle information according to two different embodiments of the present invention.

FIG. 3 is a flow chart depicting steps of a method for transmitting and receiving vehicle information according to an embodiment of the present invention.

FIG. 4 is a flow chart depicting steps of a method for transmitting and receiving vehicle information of the invention in a situation that the vehicle information transmitting method is applied in a public transportation bus system or a tour bus system.

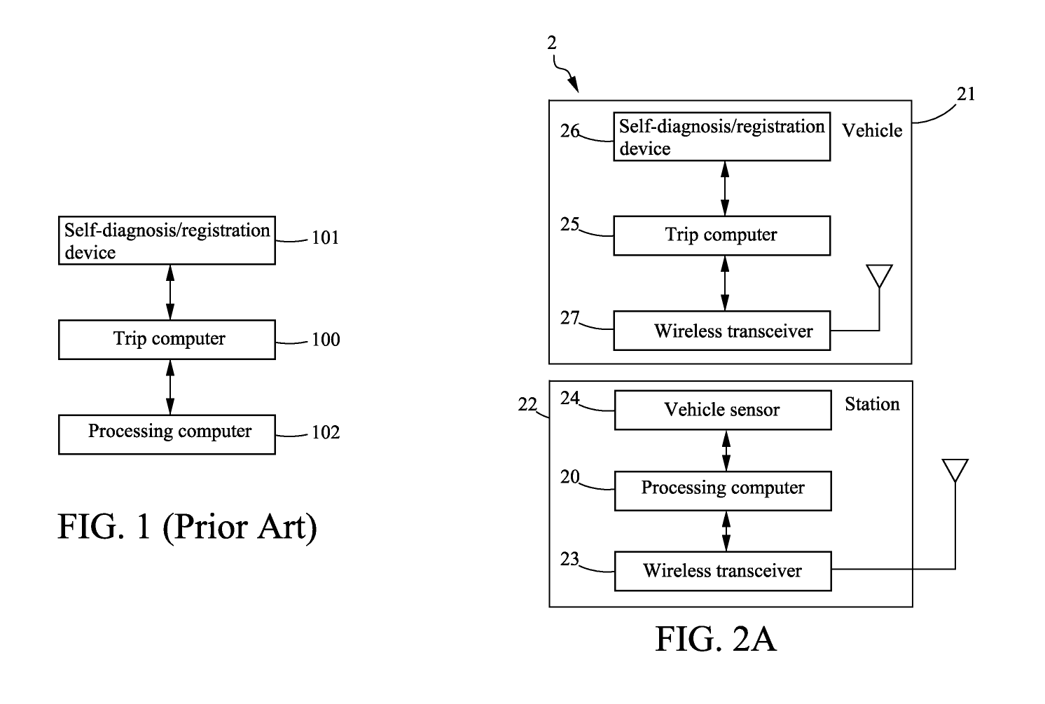

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

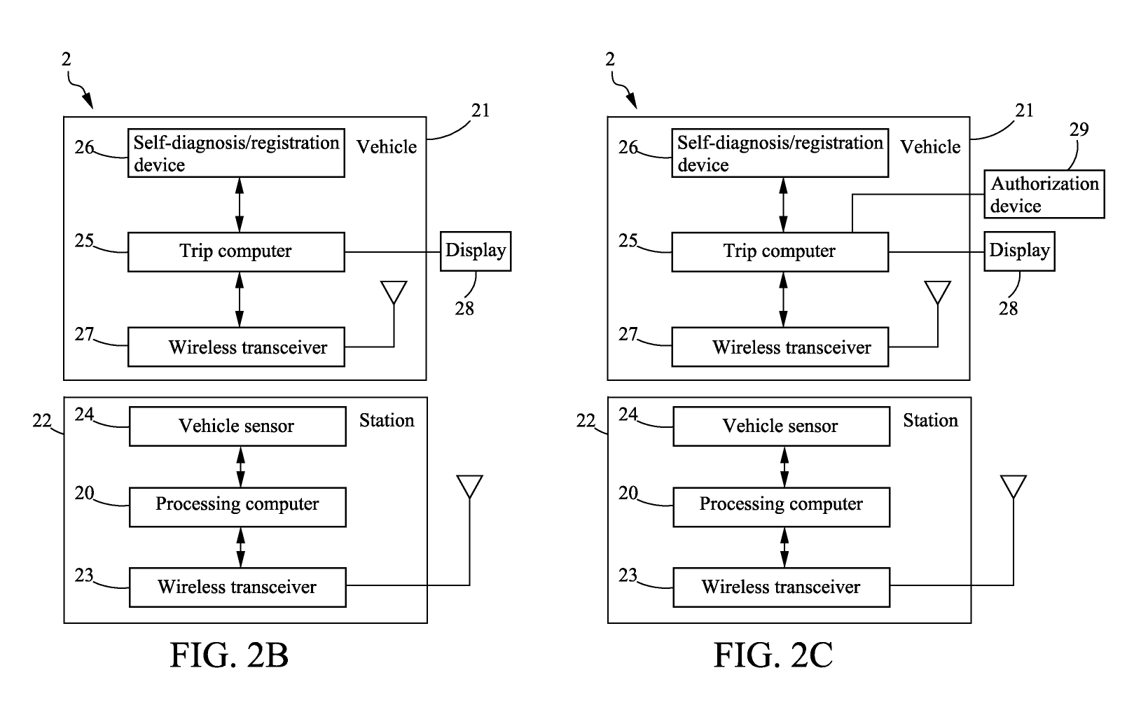

Please refer to FIG. 2A, which is a schematic diagram showing a system for transmitting and receiving vehicle information according to an embodiment of the present invention. The vehicle information communicating system 2 comprises a processing computer 20 and a vehicle 21, in which the processing computer 20 is disposed in a vehicle station 22, and is further connected with a wireless transceiver 23. In addition, there is a vehicle sensor 24 being arranged in the vehicle station 22 that is electrically connected to the processing computer 20 so as to be used for detecting any vehicle entering the vehicle station 22. In an embodiment of the invention, the vehicle sensor 24 can be a photo sensor or an imaging device, while the vehicle station 22 can be a maintenance store or a service stop. It is noted that the vehicle sensor 24 is not an essential component for the present invention, that it can disposed if required, and if there is no such vehicle sensor in the system of the invention, the sensing of the vehicle can be performed manually and visually by human eyes. In addition, the service stop can be any vehicle service facility, such as a public transportation bus terminus or a tour bus terminus. That is, there can be a plurality of vehicles that are parking in the service stop at the same time, whereas the plural vehicles are used for providing various riding services according to their different routings.

In this embodiment, the vehicle 21 is configured with a trip computer 25 that is further connected to a self-diagnosis/registration device 26 and a wireless transceiver 27. The self-diagnosis/registration device 27 is configured with a variety of sensors for detecting all kinds of operation statuses relating to the vehicle 21 that is operating, including the brake condition, the amount of lubricant, the current lubricating condition of the vehicle, the amount of water in the water tank, exhaust emission condition, the ignition condition, the temperature of the vehicle the generator status of the vehicle the battery status of the vehicle, the lighting status of the vehicle, and so on, while enabling the information resulting from the detection of those sensors to be registered into the trip computer 25. Thus, the trip computer is enabled to record a first information relating to the vehicle 21, whereas the first information includes self-diagnosis records of the vehicle that are resulting from the self-diagnosis/registration device 26, a vehicle registration data of the vehicle 21, and the maintenance records of the vehicle 21, etc. It is noted that the vehicle registration data of the vehicle 21 contains the information of the vehicle license plate, the owner, the date of manufacture, the brand, the type, or the insurance, etc., but is not limited thereby and moreover, the maintenance records of the vehicle 21 are referring to the maintenance history of the vehicle 21. In this embodiment, the trip computer 25 is designed to act according to an inquiry signal issued from the processing computer 20 for transmitting data registered in the trip computer 25 to the processing computer 20 by the use of the wireless transceiver 27. It is noted that communication protocol used by the two wireless transceivers 23, 27 can be the IEEE 802 Wi-Fi protocol, ZigBee communication protocol, ultra wide-band (UWB) protocol, general packet radio service (GPRS) protocol, or Bluetooth, and so on, but is not limited thereby.

Please refer to FIG. 2B, which is a schematic diagram showing another system for transmitting and receiving vehicle information according to another embodiment of the present invention. The system shown in this embodiment is structured similar to the one shown in FIG. 2A, but is different in that: there is a display 28 mounted on the vehicle 21 that is electrically connected with the trip computer 25 for displaying information registered in the trip computer 25 as well as the information transmitted from a remote computer, such as the processing computer 20. Please refer to FIG. 2C, which is a schematic diagram showing a system for transmitting and receiving vehicle information according to further another embodiment of the present invention. The system shown in FIG. 2C is structured similar to the one shown in FIG. 2A, but is different in that: the trip computer 25 is further connected to an authorization device 29 which is used for providing an authorization code as well as evaluating the correctness of the same, whereas the authorization device 29 is capable of establishing an information linage with the processing computer 20 so as to prevent any maintenance store from accessing to the trip computer 25 of the vehicle 21 without having proper authorization. It is noted that the authorization code of the authorization device 29 can be changed each time after the trip computer 25 is accessed or at will at any time when the owner of the vehicle 21 feels like

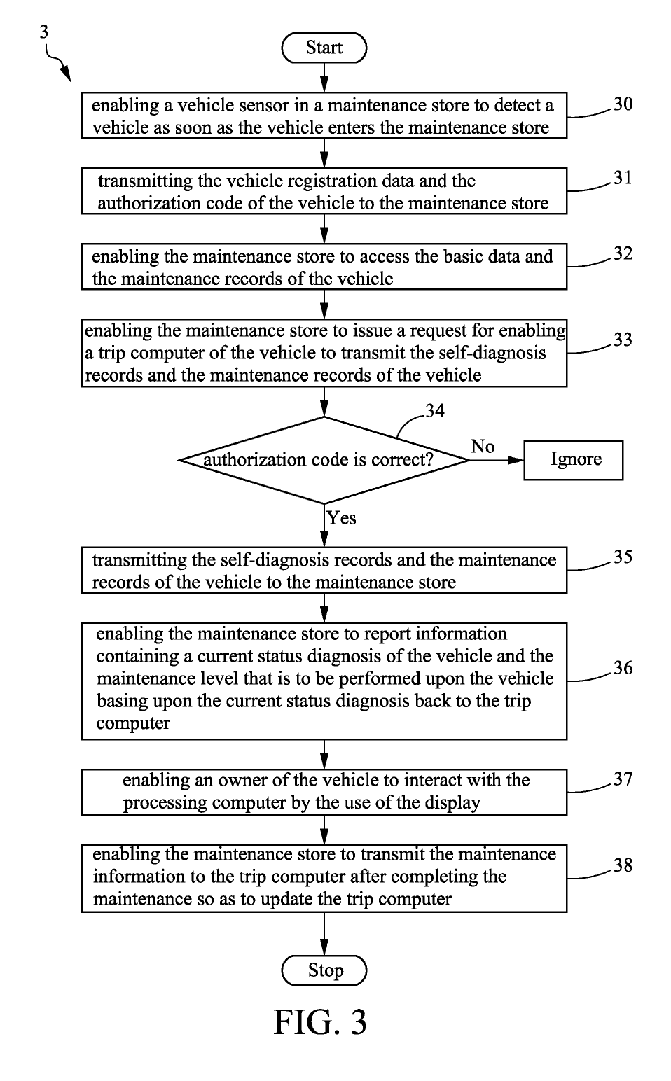

Please refer to FIG. 3, which is a flow chart depicting steps of a method for transmitting and receiving vehicle information according to an embodiment of the present invention. For illustration, the flow chart of FIG. 3 is applied in the system shown in FIG. 2C. The flow of FIG. 3 starts from the step 30. At step 30, a vehicle sensor in a maintenance store is activated to detect a vehicle as soon as the vehicle enters the maintenance store; and then the flow proceeds to step 31. At step 31, the vehicle registration data and the authorization code of the vehicle is transmitted to the maintenance store; and then the flow proceeds to step 32. It is noted that the information transmission performed in the step 31 is either actively and automatically triggered by the vehicle 21, or activated by the driver driving the vehicle by the pressing of a control button inside the vehicle 21. As for the timing for pressing the control button, it can be specified to be the time when the vehicle reaches a specific location, or when the maintenance store signals the driver by lighting, etc. Nevertheless, there can a various ways for starting the information transmission performed in step 31 that it is not limited by the foregoing examples. Moreover, the authorization can be obtained in a manner other than that described in step 31. For instance, the maintenance store can have access to the correct authorization code directly from the owner.

At step 32, the maintenance store is enabled and permitted to access the basic data and the maintenance records of the vehicle; and then the flow proceeds to step 33. It is noted that the basic data of the vehicle can include all the item numbers of the parts used in the vehicle, and the type of lubricant, and so on, while the maintenance records of the vehicle can include the information relating to all the parts being changed or maintained in the maintenance history of the vehicle. In this embodiment, the maintenance records of the vehicle can include the information relating to the being changed or maintained in a prior maintenance process performed upon the vehicle. At step 33, the maintenance store is enabled to issue a request and sending an authorization code to the vehicle for enabling a trip computer of the vehicle to transmit the self-diagnosis records and the maintenance records of the vehicle to the processing computer; and then the flow proceeds to step 34. At step 34, an evaluation is made for determining whether is authorization code is correct; if so, the flow will proceeds to step 35; otherwise, the request will be ignored. At step 35, the self-diagnosis records and the maintenance records of the vehicle are transmitted to the maintenance store in a wireless manner, while the authorization code will be changed by an authorization device coupled to the trip computer to be used in a next maintenance process; and then the flow proceeds to step 36. It is noted that there are plenty of mechanisms for sending and confirming the authorization code, the mechanism described in the present embodiment is only one of those ways, and thus is not limited thereby.

As soon as the processing computer receives the information transmitted from the trip computer, the step 36 is executed for enabling the processing computer of the maintenance store to generate and report a second information basing upon a current status diagnosis resulting from the self-diagnosis records and the maintenance records back to the trip computer; and then the flow proceeds to step 37. It is noted that the second information will contain the maintenance procedures to be performed in this maintenance process, the information relating to the oils to be replaced, a cost of the maintenance process, and so on. Moreover, the second information can be display on the display inside the vehicle for viewing of the driver. After the second information is viewed by the driver, the driver is able to interact with the processing computer, as described in step 37. It is noted that the driver is able to interact with the processing computer basing upon to the second information in a manner that the driver can perform a selection/deletion procedure upon a data containing parts that are to be changed according to the second information for deleting a portion of the parts from the second information; and then the result of the selection/deletion procedure is transmitted to the processing computer in a wireless manner. However, the driver is able to perform the selection/deletion procedure by directly communicating with a maintenance personnel without interacting with the processing computer. The purpose of the selection/deletion procedure is deigned for the driver to choose his/her preferred parts or brands of lubricant that may not be the same as those displayed in the second information.

Then, after the driver left the vehicle, the maintenance personnel of the maintenance store will start to perform a maintenance process upon the vehicle; and after the maintenance process is completed, the step 38 is executed for enabling the maintenance store to transmit an other second information to the trip computer so as to update the trip computer. In this embodiment, the second information issued in step 38 is a notice containing the information relating to the parts and lubricants that are changed or maintained in the maintenance process, maintenance procedures being performed upon the vehicle in the maintenance process, a cost of the maintenance process, and an information relating to another maintenance process that is scheduled to be performed after the maintenance process which can be specific by mileage or next maintenance date. The information of the step 38 will be stored in the trip computer for updating. With the aforesaid information transmitting method of the invention, not only the maintenance store is able to access real-time information of the vehicle which it is going to maintained, but also the driver of the vehicle can be prevented from wasting time in the process for the maintenance store to access all the information it needs so as to provide a maintenance suggestion. Although the method of FIG. 3 is applied by the use of the system shown in FIG. 2C, it is only for illustration and thus the method can also be applied by the use of the systems shown in FIG. 2A and FIG. 2B. Since the embodiments shown in FIG. 2A, FIG. 2B and FIG. 2C are only in the existence of the display or the authorization device, the whole wireless communication in the flow of the present invention is not affected

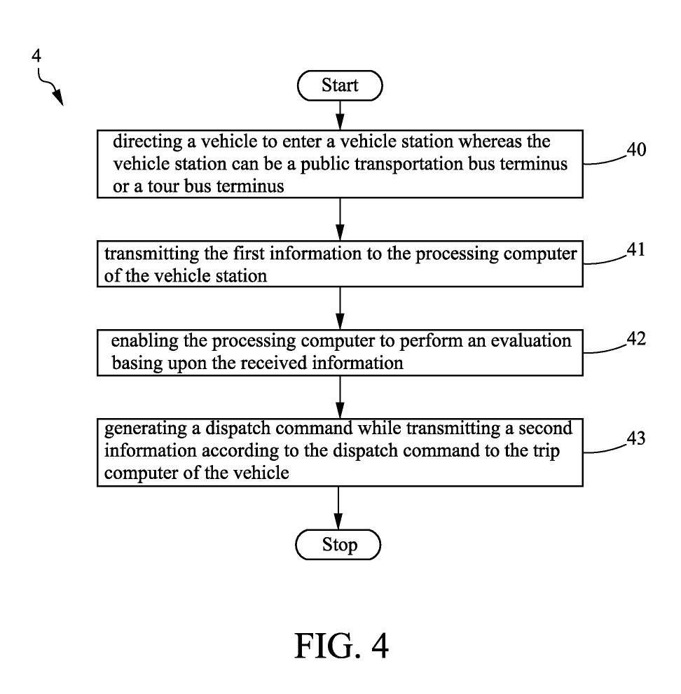

Please refer to FIG. 4, which is a flow chart depicting steps of a method for transmitting and receiving vehicle information of the invention in a situation that the vehicle information transmitting method is applied in a public transportation bus system or a tour bus system. It is noted that the method of FIG. 4 can be applied by the use of any system shown in FIG. 2A˜2C. The flow of FIG. 4 starts from the step 40. At step 40, a vehicle is directed to enter a vehicle station, whereas the vehicle station can be a public transportation bus terminus or a tour bus terminus and then the flow proceeds to step 41. At step 41, as soon as the vehicle is detected by a vehicle sensor in the vehicle station, a request will be issued for enabling the vehicle to transmit a first information to the processing computer of the vehicle station in a wireless manner; and then the flow proceeds to step 42. It is noted that the first information includes a vehicle registration data of the vehicle, trip records of the vehicle, self-diagnosis records of the vehicle, and maintenance records of the vehicle. Moreover, in this embodiment, the trip records of the vehicle should include a record of speed change during the trip, the amount of time used in the trip, and so on. However, it there are bio sensors fitted on the wheel of the vehicle for recording physiological statuses of the driver, those recorded physiological statuses can also be included in the trip records of the vehicle, by that the physiology of the driver can be monitored so as to prevent the passengers from any danger caused by the health condition of the driver.

After the first information is received by the processing computer, the step 42 is performed for enabling the processing computer to perform an evaluation basing upon the received information; and then the flow proceeds to step 43. By the evaluation performed in step 42, abnormalities can be detected, which includes speeding, abnormal physiological statuses of the driver, or any abnormality in the self-diagnosis records. Thereby, it is possible to response to those abnormalities in real time. For instance, if the driver is speeding during the trip, a warning or punishment can be issued to the driver; or if there are abnormalities found in the self-diagnosis records, the vehicle can be send to be maintained; or if the bio sensor detects abnormal physiological status, the driver should be subjected to a complete health check. Finally, before the vehicle is being dispatched, the step 43 is performed for enabling the processing computer to generate a dispatch command while transmitting a second information according to the dispatch command to the trip computer of the vehicle, whereas the second information will include a route for the vehicle, an information relating to the speed limit for each leg containing in the route and an information relating to each stop in the route.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A method for transmitting and receiving vehicle information, comprising the steps of:
providing a vehicle having a wireless transceiver and a trip computer while enabling the trip computer to record a first information relating to the vehicle;
transmitting the first information to a processing computer in a wireless manner when the vehicle enters a vehicle station; and
enabling the processing computer to transmit wirelessly a second information at a specific point of time to the trip computer.

2. The method of claim 1, wherein the vehicle station is a maintenance store and the first information includes a vehicle registration data of the vehicle, self-diagnosis records of the vehicle, an authorization code relating to the vehicle and maintenance records of the vehicle.

3. The method of claim 1, wherein the vehicle is further configured with a display to be used for displaying the second information; and when the specific point of time is a time point before a maintenance process is performed upon the vehicle, the second information will include an information relating to the parts that are to be changed in the maintenance process, a cost of the maintenance process, and maintenance procedures being performed upon the vehicle in the maintenance process.

4. The method of claim 1, further comprising the step of:
basing upon to the second information to perform an interaction operation with the processing computer while designing the interaction operation to be performed in a manner comprising the steps of:
performing a selection/deletion procedure upon a data containing parts that are to be changed according to the second information for deleting a portion of the parts from the second information; and
transmitting the result of the selection/deletion procedure to the processing computer in a wireless manner.

5. The method of claim 1, wherein the specific point of time is a time point after completing a maintenance process upon the vehicle, the second information from the processing computer further will include a notice, an information relating to the parts that are changed in the maintenance process, a cost of the maintenance process, and an information relating to another maintenance process that is scheduled to be performed after the maintenance process.

6. The method of claim 1, wherein the vehicle station is a service stop and the first information includes a vehicle registration data of the vehicle, trip records of the vehicle, self-diagnosis records of the vehicle, and maintenance records of the vehicle.

7. The method of claim 6, wherein when the specific point of time is defined to be the time when the vehicle is departing from the vehicle station, the second information will include a route for the vehicle, an information relating to the speed limit for each leg containing in the route and an information relating to each stop in the route.

8. The method of claim 1, wherein when the data containing in the first information are self-diagnosis records of the vehicle, a vehicle registration data of the vehicle and maintenance records of the vehicle, the following steps should be comprised and executed in the method before the step for transmitting the first information to the processing computer:
receiving an inquiry signal and an authorization code from the processing computer in a wireless manner; and
making an evaluation to determine whether the authorization code is correct or not; if so, enabling the first information to be transmitted to the processing computer.

9. A system for transmitting and receiving vehicle information, comprising:
a processing computer, disposed inside a vehicle station; and
a vehicle, further comprising:
a trip computer, for recording a first information relating to the vehicle, and
a wireless transceiver, for transmitting the first information to the processing computer when the vehicle enters the vehicle station;
wherein the processing computer is enabled to transmit wirelessly a second information at a specific point of time to the trip computer of the vehicle.

10. The system of claim 9, wherein the vehicle station is a maintenance store and the first information includes a vehicle registration data of the vehicle, self-diagnosis records of the vehicle, an authorization code relating to the vehicle and maintenance records of the vehicle.

11. The system of claim 9, wherein the vehicle is further configured with a display to be used for displaying the second information; and when the specific point of time is a time point before a maintenance process is performed upon the vehicle, the second information will include an information relating to the parts that are to be changed or maintained in the maintenance process, a cost of the maintenance process, and maintenance procedures being performed upon the vehicle in the maintenance process.

12. The system of claim 9, wherein when the specific point of time is a time point after completing a maintenance process upon the vehicle, the second information from the processing computer further will include a notice, an information relating to the parts that are changed in the maintenance process, a cost of the maintenance process, and an information relating to another maintenance process that is scheduled to be performed after the maintenance process.

13. The system of claim 9, wherein the vehicle station is a service stop and the first information includes a vehicle registration data of the vehicle, trip records of the vehicle, self-diagnosis records of the vehicle, and maintenance records of the vehicle

14. The system of claim 13, wherein when the specific point of time is defined to be the time when the vehicle is departing from the vehicle station, the second information will include a route for the vehicle, an information relating to the speed limit for each leg containing in the route and an information relating to each stop in the route.

15. The system of claim 9, wherein the trip computer is further connected to an authorization device which is used for providing an authorization code as well as evaluating the correctness of the same.

16. The system of claim 9, wherein the processing computer further connected to a vehicle sensor, which is disposed at the vehicle station to be used for detecting the vehicle.
